(19) United States
(12) Patent Application Publication
(10) Pub. No.: US 2004/0133410 A1
(43) Pub. Date: Jul. 8, 2004

(54) Determining field-dependent characteristics by employing high-order quadratures in the presence of geometric singularities

(76) Inventors: Joseph Franklin Ethridge, Hamden, CT (US); Zydrunas Gimbutas, Hamden, CT (US); Leslie F. Greengard, New York, NY (US); Vladimir Rokhlin, Hamden, CT (US); William Y. Crutchfield, Pleasonton, CA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/657,729

(22) Filed: Sep. 8, 2003

Related U.S. Application Data
(60) Provisional application No. 60/408,674, filed on Sep. 6, 2002.
(60) Provisional application No. 60/412,431, filed on Sep. 20, 2002.

(51) Int. Cl. G06F 17/50

(52) U.S. Cl. 703/14

(57) ABSTRACT

A machine for determining field-dependent physical characteristics contains tables of precomputed quadratures and employs them to integrate numerically over a problem boundary. The quadratures are based on products of a kernel function and a basis that spans a wide range of density functions. The kernel function is dependent on a target node's position, and different quadratures are precomputed for different target-node positions or ranges thereof. In the case of at least some of the quadratures, some the basis functions include integrable singularities. The solver divides the problem boundary into a plurality of problem intervals, to which it maps the canonical interval. To integrate a problem interval for a target point, the solver employs a precomputed quadrature that is associated with the target point's relative position and that was generated by using a basis in which a singularity occurs at each canonical-interval location that was mapped to a geometrical singularity on the problem interval. The quadrature results in high-order accuracy even if no individual basis function includes a singularity whose shape is the same as one induced by the geometric singularity. These quadratures can be coupled with a Fast Multipole Method (“FMM”) to evaluate layer potentials rapidly and with high accuracy.

### CROSS-REFERENCE TO RELATED APPLICATIONS

This application claims the benefit of U.S. Provisional Patent Application No. 60/408,674, which was filed on Sep. 6, 2002, by Greengard et al. for High Order Quadrature Techniques for Integral Equations, and U.S. Provisional Patent Application No. 60/412,431, which was filed on Sep. 20, 2002, by Greengard et al. for an FMM Toolbox. We hereby incorporate both applications in their entirety by reference.

### BACKGROUND OF THE INVENTION

1. Field of the Invention

The present invention is directed to methods and apparatus for simulating and determining physical characteristics by performing numerical integration to solve field equations.

2. Background Information

Machines used in designing devices in which electrostatic properties are important often need to compute values of the scalar electrical-potential function φ by numerically finding solutions to the following equation:

∇²φ(x)=ρ(x)/ε, (1)

where x is ρ is charge density and ε is electrical permittivity. When electrodynamic properties are involved, the relevant equation is often

∇²φ(x)+ω²μεφ(x)=−ρ(x)/ε, (2)

where ω is the (radian) driving frequency and μ is magnetic permeability.

Problems that involve magnetostatics often deal with a “vector potential” A, which is defined as the curl of magnetic flux density. Finding that quantity can involve solving the following:

∇²A(x)=−μJ(x), (3)

where J is the current density. In the dynamic case, the relationships are often expressed:

∇²A+ω²μεA(x)=−μJ(x), (4)

Although the potential and density functions have vector rather than scalar ranges, the last two equations are actually two sets of scalar equations in the vectors' components, so solving those equations involves the same procedures as solving the first two does.

In problems involving the flow of incompressible fluids, a potential vector Ψ, of which the flow velocity is the curl, maintains the following relationship with the vorticity vector w:

∇²Ψ(x)=w(x). (5)

Yet another example occurs in physics problems such as molecular-structure calculations, in which the “screened” electrostatic potential φ bears the following relationship to charge density ρ.

∇²φ(x)−λ²φ(x)=ρ(x), (6)

where λ is the Debye length.

To obtain unique solutions to these equations, boundary values must be applied. We can generalize such equations and their boundary values as follows:

L[u(x)]=f(x), x within S,

b[u(x)]=h(x), x on B, (7)

where L is one of the above operators, such as ∇² or ∇²+ω²με, u(x) is a function to which the operator is applied, f(x) is a forcing function, such as ρ(x), w(x), or −μJ(x), S is a region (typically a volume or an area) within which f is defined, B is S's boundary (typically a closed curve or surface), and b is an operator that, together with a function h whose domain is on B, defines the boundary conditions.

For the sake of convenience, we will refer to u as the “potential function,” although in some applications it may represent a quantity that is not necessarily considered a potential.

A common approach to solving problems of that general type employs a representation of the potential function u as

$$u ( x ) = {\int }_{S} G ( x , y ) f ( y ) ⅆ y + {\int }_{B} M ( x , y ) σ ( y ) ⅆ y , \qquad ( 8 )$$

where σ is an unknown surface density on B, G(x,y) is the so-called Green's function associated with the operator L, and M is a function derived from G. M is typically G itself or some derivative of G. If the operator L is simply ∇², then G is (½π) log |x−y| in 2D, ¼π|x−y| in 3D. The representation (8) automatically satisfies the first PDE in (7), and it remains to satisfy the boundary in (7)'s second equation. For this we take limit as x approaches B and obtain the following boundary integral equation (BIE) for σ:

h(x)−b(∫_{S}G(x,y)f(y)dy)=D(x)σ(x)+∫_{B}K(x,y)σ(y)dy. (9)

The precise forms of K and D depend on the choice of M and the limiting process. In the example below, Equation (9) is the equation that will be discretized and solved, and, for convenience, the function σ(y) will be referred to as the “density” function, although it will be apparent that the techniques of the present invention will be applicable to functions for which the represented quantity is not necessarily considered a density.

By using discrete versions of these equations, a computer can solve numerically for various of the functions involved. Suppose, for example, that the problem is to find the capacitance per unit length, i.e., the charge per unit length per unit potential difference, between a pair of long conductors. The problem is to assume a unit potential difference between the surfaces and then integrate the (surface) charge density over the surfaces to find the total charge. Since there is no charge within the region “bounded” by the conductors—i.e., the only charge in the system is located on the conductor surfaces themselves—equation (8)'s function f(x), which in this case is (volume) charge density divided by electrical permittivity, is identically zero.

So the representation (8) takes the simpler form:

u(x)=(½π)∫_{B} log|x−y|σ(y)dy, x within S, (10)

where we have chosen M=log. Taking limits, (10) becomes

h(x)=u(x)=(½π)∫_{B} log|x−y|σ(y)dy, x on B, (11)

where h is potential on conducting surface. For capacitance, h(x)=1 for x on one conductor's surface and h(x)=0 for x on all others.

Numerically, this equation would be approximated by the discrete version h=Aσ, i.e.,

$$[ \begin{matrix}h ( {x}_{1} ) \\ ⋮ \\ h ( {x}_{i} )\end{matrix} ] = [ \begin{matrix}{A}_{1 , 1} & ⋯ & {A}_{1 , M} \\ ⋮ & ⋰ & ⋮ \\ {A}_{I , 1} & ⋯ & {A}_{I , M}\end{matrix} ] [ \begin{matrix}σ ( {y}_{1} ) \\ ⋮ \\ σ ( {y}_{M} )\end{matrix} ] , \qquad ( 12 )$$

where the matrix A's elements A_{i,m} depend on the integrand's xᵢ-dependent factor, e.g., on log|x−y| when the operator is a two-dimensional Laplacian. Now, since the solver is in this case is intended to find the charge-density values rather than the potential values, it may instead employ the inverse matrix:

σ=A⁻¹h,

but it would be more typical in the case of large matrices for the solver to employ successive-approximation techniques instead of actually inverting the matrix.

Accuracy in numerical integration depends of the selection of quadrature, i.e., on the choice of integration-interval locations and weights to be applied to the integrand's values at those locations before summing the results to approximate the integral. Consider an integration region segment treated as a single interval numerically integrated in accordance with a quadrature in which nodes are equally spaced and weighted equally. If the resulting error is ε₁, one could expect an improvement to something on the order of ε₁/n² if the segment is instead divided into n such intervals. With a judiciously chosen quadrature, on the other hand, one can often observe a reduction to something like ε₂/n¹⁰ with n intervals if the error is ε₂ for a single interval. Quadratures that result in such fast increases are often referred to as “high-order” quadratures. In high-computation-cost numerical problems, quadratures are sometimes employed to avoid costs that could be prohibitive if simple uniform node spacing were used.

Among the difficulties encountered in numerical integration are those that arise when the integrand includes one or more singularities. A typical Green's function G(x,y), for example, will have a singularity at x=y. At geometrical discontinuities such as corners and edges, moreover, the density function, too, can have what for practical purposes can be thought of as singularities. In the case of capacitor electrodes, for example, very localized regions whose charge densities are orders of magnitude higher than in the remainder of the electrode can occur in corners. Or the rate at which the density falls off with proximity to the geometrical singularity can increase essentially without bound.

Standard integral equation techniques suffer from a loss of accuracy when they are applied to geometric singularities. When standard numerical-integration techniques are used in the presence of singularities such as those presented by edges and corners, three procedures can generally be used to achieve high order accuracy.

One approach to addressing singularities generally includes approximating the density function, σ(y), by, for example, employing a piecewise-constant function on a piecewise-linear representation of the boundary. Exact (e.g., analytic) integration techniques are then applied to the approximated density function. But there are practical difficulties in obtaining relatively accurate representations of either the density or the boundary for target points on or near the boundary.

Another is to use asymptotics, that is, to create special solutions that take into account the precise details of the corner or edge under consideration. This is difficult to accomplish in three dimensions, requires a lot of special cases, is difficult to automate, and does not couple naturally to an integral-equation approach for the remainder of the analysis.

A new generation of high-order-quadrature techniques was introduced in a sequence of papers by Alpert, Kapur, Ma, Rokhlin, Strain, Wandzura, Xiao, and Yarvin over the last few years. In one dimension, such techniques have been to derive quadratures by evaluating integrals of the form:

F=∫₀¹G(0,y)σ(y)dy,

and fixing the target point at the beginning of the integration interval. By translating the coordinate system, the same rule can be applied to an arbitrary segment. There are several deficits in this approach when considering boundary integral equations. These derived quadrature rules do not facilitate integral evaluation when a target point is off the boundary or on a neighboring segment. The solution to this problem has been to treat such cases as “smooth” integrals and to use standard high-order quadrature rules such as Gaussian quadrature for the evaluation.

With this approach, the incorporation of high-order rules into integral-equation solvers for Maxwell's equations, the Laplace equation, and related problems of potential theory is feasible, but not nearly optimal. To be more concrete, imagine a boundary interval Γ₀ and a neighboring boundary interval Γ₁ joined to it to create a geometric singularity, as FIG. 1 illustrates.

In some circumstances, we need to evaluate the integral over Γ₀ at target points X₁ off the boundary. In virtually any integral-equation technique, we need to evaluate the integral over Γ₀ at target points on the same boundary segment (X₂) or on different segments (X₃). We are not aware of any existing fast and robust techniques for developing such quadratures, especially when Γ₀ is not a linear segment (2D) or a triangle (3D) and/or the boundary segment Γ₀ participates in a corner, typically inducing a singularity in the density function σ(y).

A fourth approach includes a “graded mesh,” which clusters points systematically at the edge or corner. While this approach can be automated, it uses many more (e.g., by at least an order of magnitude) sample points near the singularity than in other parts of the boundary. This can adversely affect iterative solution convergence.

High accuracy can be achieved despite such singularities when appropriate quadratures are used. Unfortunately, the task of designing a quadrature appropriate to the particular task has in the past been involved, so its cost tended to compromise the advantages of quadrature use.

### SUMMARY OF THE INVENTION

We have developed a way to address the loss of accuracy that standard integral-equation techniques exhibit in the presence of geometric singularities such as edges and corners. By using our approach, high-order accuracy can be achieved without the need for graded or adaptive meshes in the vicinity of the geometric feature. As a result, fewer sample points are needed to resolve the solution. We have recognized that the quadratures can be selected in a way that better lends itself to automatic implementation.

As will be explained in due course, the solver includes tables of “canonical” quadratures for respective distances (or ranges) of the target point x from a canonical integration interval. (The interval can have one or more dimensions. For two-dimensional problems, the canonical interval is typically a straight line segment. For three-dimensional problems, it is typically a flat triangle. Higher-dimensional intervals can be used for higher-dimensional problems.) By relatively inexpensive mapping of the canonical interval to problem intervals into which a problem boundary has been divided, the solver employs the canonical intervals to integrate over the problem intervals.

Our technique is based in part on our following observation. Independently of the actual form of the singularity that is actually encountered, a quadrature that results in high-order accuracy can be obtained by representing the density function that includes a general fixed-form singularity, i.e., that includes a singularity chosen independently of the various precise forms of density-function singularity that will be encountered when the quadrature is used.

For example, a quadrature based on basis functions of the general form

σ(y)=f(y)+(log|y|)g(y)

where f(y) and g(y) are smooth functions, such as polynomials, will result in quadratures that result in high-order accuracy even when the singularity in the actually encountered density function is of the form, say,

σ(y)=f(y)+(√y)g(y) (at y=0)

or

σ(y)=f(y)+(1/√y)g(y) (at y=0).

The quadratures that the solver employs for a given problem are obtained at problem-solution time from these “canonical” quadratures by relatively inexpensive mapping. Although computing the canonical quadratures is quite computation-intensive, it does not have to be done more than once. The stored results are then available for use thereafter in all problems.

Preferably, the solver performs the actual numerical integration by adapting a Fast Multipole Method (“FMM”), employing “far-field” quadratures in that operation, as will be explained below. In the course of its calculation, this produces an adaptive quad-tree (2D) or oct-tree (3D) subdivision of space around all segments/triangles and any auxiliary target points. For each of the intervals into which the boundary is divided, the resultant boxes in the adaptive tree that contain nodes lying on that interval are considered to form a “cover” of that interval, and that cover is extended until it covers all the points within some user-specified distance of the interval. Then, for each target point in the cover, the solver replaces the FMM-computed contribution with a contribution computed in accordance with a quadrature determined as described above.

### BRIEF DESCRIPTION OF THE DRAWINGS

The invention description below refers to the accompanying drawings, of which:

FIG. 1, mentioned above, is a diagram that illustrates the possible relationships between target nodes and integration intervals;

FIG. 2 is a block diagram of a computer system in which the present invention's teachings may be embodied;

FIG. 3 is a cross-sectional view of a pair of conductors between which the capacitance is to be computed; and

FIG. 4 is a diagram illustrating regions for which the illustrated embodiment determines different sets of quadratures.

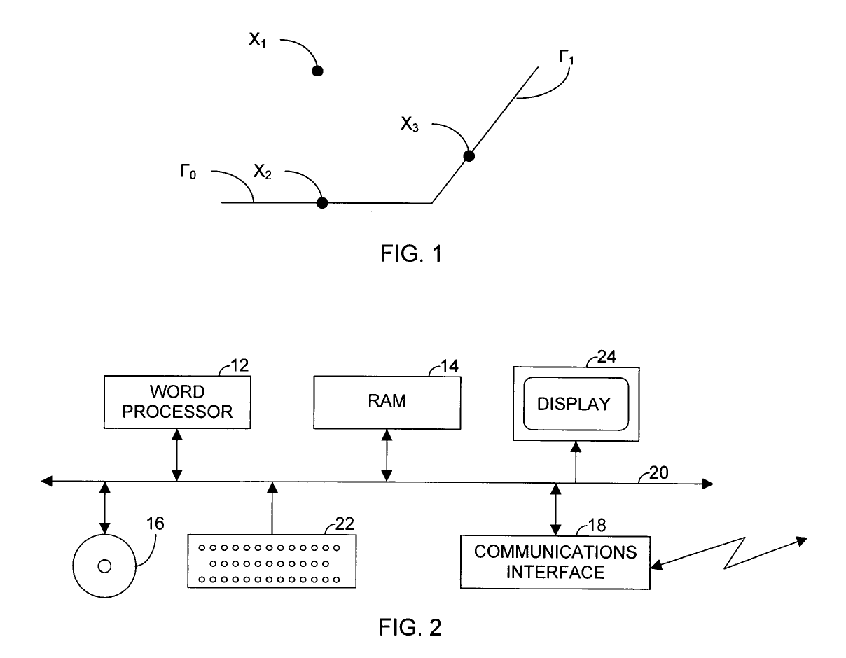

### DETAILED DESCRIPTION OF AN ILLUSTRATIVE EMBODIMENT

The solver of the present invention can be embodied in a wide variety of circuitry. A typical approach will be to implement it in a computer system. FIG. 2 depicts a typical computer system 10 in a highly simplified fashion. The data and instructions for operating on them that a microprocessor 12 uses may reside in system read/write memory (“RAM”) 14, which in turn may be loaded from various peripheral devices, such as a system disk 16 or some type of communications interface 18 through a system bus 20. Most computer systems will additionally include other input devices, such as a keyboard 22, and results would be presented through the communications interface 18, a visual display 24, or in some other manner. Although the drawing shows only a single microprocessor, multiprocessor systems will likely employed in many embodiments.

In any event, instructions that configure the computer system as a solver that implements the present invention's teachings will in most embodiments be contained in local storage such as the disk 16, but the computer may instead receive electromagnetic signals representing them through the communications interface. Ordinary wire pairs or coaxial cable would usually conduct such signals, but the signals may also be guided or unguided radio-frequency radiation, microwaves, or visible or invisible light.

The solver's user would supply it with a definition of a problem that lends itself to integral-equation solution. The user may be a human being who enters information at the keyboard, possibly with the assistance of some other input device, but it will often be some other computer-implemented apparatus implemented in the same computer or some remote one. For example, the user may be a computer-implemented design system that is designing a two-conductor configuration and needs to know the capacitance between the conductors. To that end, it would describe the conductor shape and the quantities that the solver is to determine.

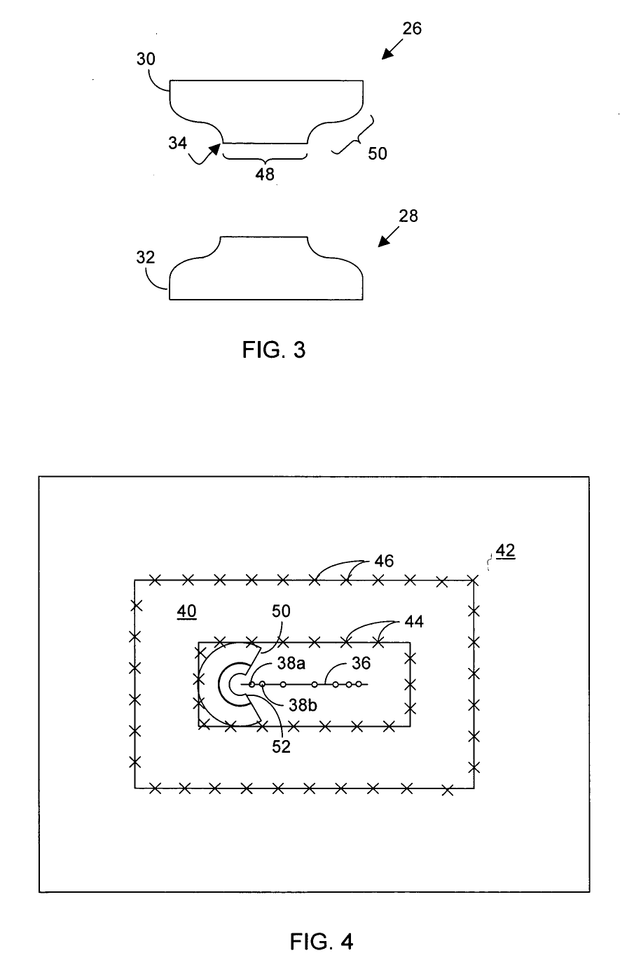

For example, it may specify two long conductors' shapes in cross section, indicating that their contours are as FIG. 3 indicates. That is, two conductors 26 and 28 are described by respective boundaries 30 and 32. Also, since the physical quantity of interest, namely, capacitance, is a ratio of charge to potential difference, it can be determined by finding what the charge on the conductors is when there is a unit potential difference between them. So solution to ∇²φ(x)=ρ(x)/ε needs to be found for this configuration; i.e., the operator L is the Laplacian, the potential function u is φ(x), and the forcing function is ρ(x)/ε. The solver therefore needs to solve an integral equation of the type mentioned above, and, to achieve high accuracy inexpensively, an appropriate quadrature selection is desirable.

Conventionally, the quadrature selection would be somewhat involved for the user. The user would conventionally have had to tailor the quadrature to the problem, since it ostensibly depends on the integrand, i.e., on the type of operator (∇², ∇²+k², ∇²−k², etc.) that defines the problem, on the relative positions of the target location x and the integration interval (e.g., what the angles are on any corners), on the integration interval's shape, and on the density function σ's values in that interval.

A particular problem in this connection involves geometric singularities. Vertex 34 is an example of a geometric singularity: there is a discontinuity in the boundary's tangent. Such singularities present numerical-integration difficulties in field problems because they give rise to singularities in the resultant density functions: at the geometric singularities, the magnitudes of the density functions or their derivatives increase without bound.

In some problems, geometric singularities are known to induce functions such as the sum of (1) a smooth function and (2) the product of a smooth function and (t−t₀)^{α}, where −1<α<1. For α≠0, the magnitude of such a function and/or its derivative increases without bound as t approaches t₀: the function is singular at t₀. Traditional quadrature techniques do not yield high-order quadratures for functions that include such singularities.

Now, the relationship between α and the geometric angle formed at the singularity is known for many problems. So, when some existing solvers encounter a geometric singularity, they compute a specialized quadrature based on the particular α value that would result from that geometrical singularity's angle.

In contrast, we have recognized that a quadrature can be obtained that will yield high-order convergence relatively independently of angle, so solvers that employ the present invention's teachings need not resort to such computation-intensive “on-the-fly” quadrature design. Although the quadrature design is still computation-intensive, it need not be performed for each encountered angle; the same quadrature can be used for a range of angles.

In the illustrated embodiment, for example, a single range includes all angles likely to be encountered. Other embodiments may employ several ranges. That is, they may compute a separate quadrature for each range, computing each from a different set of basis functions, the theory being that some optimization may thereby result. Still, the invention's advantages are most manifest when the number of ranges is kept small enough that pre-computing the quadratures and storing them remains practical. Given the current cost of computer performance, it is best if the number of ranges is no more than a thousand, and preferably no more than a hundred.

The approach that we take is for the solver to contain tables of pre-computed, “canonical” quadratures, whose nodes are specified in terms of positions in a canonical integration interval in a “canonical” space. As was mentioned above, the canonical quadratures are derived in a way that is, at least throughout an angle range, independent of the angle of any geometric singularity. To solve a specific problem, that canonical integration interval is mapped onto a “problem” interval, i.e., a segment of the boundary over which integration is to occur in the real-world problem.

We will describe the canonical-quadrature computation by reference to the two-dimensional case, of which FIG. 3 depicts part of an example problem specification, but it will be apparent that the same basic approach is applicable to three-dimensional problems, also. In the illustrated embodiment, the canonical interval is taken to be the line segment y(t)=(t, 0) for tε[−1, 1]. (Of course, the canonical interval's length does not have to be 2. Indeed, it does not in principle have to be straight. But straight segments are convenient, and a length of 2 is as good as any.) Now, the problem to be solved is to find a quadrature, i.e., a set of J nodes tⱼ and associated weights wⱼ, such that the sum of the products of sampling an integrand of the following form at those nodes and multiplying the samples by those weights will approximate the integral to within the desired degree of accuracy:

$${\int }_{B} G ( x , y ) σ ( y ) ⅆ y ≅ {\sum }_{j = 1}^{J} {w}_{j} G ( x , {y}_{j} ) σ ( {y}_{j} ) , \qquad ( 13 )$$

where B is the above-described canonical integration interval y(t)=(t, 0) for tε[−1, 1], yⱼ≡y(tⱼ), G is one of the operator-dependent kernels variously represented above by G, M, and K, and σ is a function defined over the boundary. For the sake of convenience, we will refer to σ as the “density function,” although it may represent a quantity not normally considered a density.

When the precomputation occurs, though, σ is not known. But we have recognized that high-order quadratures can nonetheless be precomputed for such integrands. Part of the approach to doing so is to assume that σ can be approximated accurately by a linear combination of basis functions:

$$σ ( y ( t ) ) = {\sum }_{k = 0}^{K - 1} {α}_{k} {f}_{k} ( t ) , \qquad ( 14 )$$

where the fₖ's are the basis functions.

For the sake of example, consider the following the basis, which can be employed to derive quadratures that will used when the target point x is on a non-smooth interval, i.e., on an interval in which a density-function singularity may occur:

fₖ=Pₖ(t), 0≦k≦Q

f_{k-P-1}=P_{k-P-1}(t)log(t+1), Q<k<K, (15)

where Pₖ is the kth-order Legendre polynomial, Q is the highest order employed, and K=2Q+2.

Inspection of that basis reveals that half of its functions include a singularity at one end of the interval, i.e., at y(t) for t=−1. The illustrated embodiment does not base its quadrature generation on basis functions that include other singularities.

Although the ultimate accuracy depends to an extent on the basis-function choice, it turns out that the exact basis choice is not critical so long as it includes some functions in which there are integrable singularities that have the same domain locations. For example, basis functions such as

$$\frac{{P}_{k} ( t )}{\sqrt{t + 1}}$$

could be used instead.

Since the singularity in the basis occurs at t=−1, the illustrated embodiment restricts the canonical interval's mapping at problem-solution time to real intervals in which the density function will have no singularity anywhere in the interval, with the possible exception of the end to which t=−1 is mapped. Of course, other embodiments may include quadratures computed from bases in which the singularities are positioned differently. One possibility, for example, would be to employ basis functions that together include singularities at both ends so that the canonical interval can be mapped to problem intervals that do, too. As will be seen, though, the fact that the illustrated embodiment's canonical-interval mapping is restricted to intervals in which a singularity in the density function can occur only at one end does not restrict the illustrated embodiment's range of application.

Quadratures thus obtained can be used not only for non-smooth intervals but also for smooth intervals, i.e., for intervals that do not contain or end in a geometric discontinuity and on which the density function therefore is not expected to exhibit a singularity. But there is some computational savings in using simpler quadratures for non-smooth intervals, and that is what the illustrated embodiment does: for those intervals, it uses a quadrature that is based only on the first Q+1 basis functions, i.e., only on functions of the form fₖ=Pₖ(t). For a given value of x, that is, the solver of the illustrated embodiment solver includes a pair of stored quadratures, one for use on smooth problem intervals and one for use on non-smooth ones.

Despite the computational advantage of using simpler quadratures for smooth intervals, the quadrature set stored for a given x value in some other embodiments may consist of only a single quadrature, not two: the same quadrature may be used on both types of intervals. On the other hand, some embodiments may employ sets of more than two. An embodiment for which the basis employed to generate some canonical quadratures included functions that have singularities at both of the canonical-interval ends, for example, may use one type of quadrature for smooth intervals, another for intervals that have singularities only at one end, and a third for intervals that include singularities at both ends.

To find a quadrature whose use will result in close approximations to integrands in which such density functions are multiplied by a kernel function of the general expected type, we perform what we refer to as “generalized Gaussian quadrature” generation.

Specifically, if the basis is the one defined in equation (15), we solve the following system of (nonlinear) equations for the desired pairs of nodes yᵢ and associated weights wᵢ in a non-smooth interval:

$$\begin{matrix}\begin{matrix}{\int }_{- 1}^{1} 1 ⅆ t = {\sum }_{j = 1}^{J} {w}_{j} \\ {\int }_{- 1}^{1} {P}_{1} ( t ) ⅆ t = {\sum }_{j = 1}^{J} {P}_{1} ( {t}_{j} ) {w}_{j} \\ ⋮ \\ {\int }_{- 1}^{1} {P}_{Q} ( t ) ⅆ t = {\sum }_{j = 1}^{J} {P}_{Q} ( {t}_{j} ) {w}_{j}\end{matrix} \\ \begin{matrix}\begin{matrix}\begin{matrix}{\int }_{- 1}^{1} log ( t + 1 ) ⅆ t = {\sum }_{j = 1}^{J} log ( {t}_{j} + 1 ) {w}_{j} \\ {\int }_{- 1}^{1} log ( t + 1 ) {P}_{1} ( t ) ⅆ t = {\sum }_{j = 1}^{J} log ( {t}_{j} + 1 ) {P}_{1} ( {t}_{j} ) {w}_{j} \\ ⋮\end{matrix} \\ {\int }_{- 1}^{1} log ( t + 1 ) {P}_{Q} ( t ) ⅆ t = {\sum }_{j = 1}^{J} log ( {t}_{j} + 1 ) {P}_{Q} ( {t}_{j} ) {w}_{j}\end{matrix} \\ \begin{matrix}\begin{matrix}{\int }_{- 1}^{1} log \vert x - y ( t ) \vert ⅆ t = {\sum }_{j = 1}^{J} log \vert x - ( {t}_{j} ) \vert {w}_{j} \\ {\int }_{- 1}^{1} log \vert x - y ( t ) \vert {P}_{1} ( t ) ⅆ t = {\sum }_{j = 1}^{J} log \vert x - y ( {t}_{j} ) \vert {P}_{1} ( {t}_{j} ) {w}_{j} \\ ⋮ \\ {\int }_{- 1}^{1} log \vert x - y ( t ) \vert {P}_{Q} ( t ) ⅆ t = {\sum }_{j = 1}^{J} log \vert x - y ( {t}_{j} ) \vert {P}_{Q} ( {t}_{j} ) {w}_{j}\end{matrix} \\ {\int }_{- 1}^{1} log ( t + 1 ) log \vert x - y ( t ) \vert ⅆ t = {\sum }_{j = 1}^{J} log ( {t}_{j} + 1 ) log \vert x - y ( {t}_{j} ) \vert {w}_{j} \\ {\int }_{- 1}^{1} log ( t + 1 ) log \vert x - y ( t ) \vert {P}_{1} ( t ) ⅆ t = {\sum }_{j = 1}^{J} log ( {t}_{j} + 1 ) log \vert x - y ( {t}_{j} ) \vert {P}_{1} ( {t}_{j} ) {w}_{j} \\ ⋮ \\ {\int }_{- 1}^{1} log ( t + 1 ) log \vert x - y ( t ) \vert {P}_{Q} ( t ) ⅆ t = {\sum }_{j = 1}^{J} log ( {t}_{j} + 1 ) log \vert x - y ( {t}_{j} ) \vert {P}_{Q} ( {t}_{j} ) {w}_{j} ,\end{matrix}\end{matrix}\end{matrix} \qquad ( 16 )$$

where the value of Q is twice as high as in equation (15) because the kernel is assumed to be approximated by a linear combination of functions of the form Pₖ and Pₖ log|x−y|.

This is a system of 4Q+4 equations in 2J variables. For smooth-interval quadratures, the system would be smaller; the equations including the log(tⱼ+1) terms would not be included, and J would typically be chosen to be half as great as for non-smooth intervals). Although the system and number of nodes could be so chosen that the number of equations equals the number of variables, our practice is for the system to be overconstrained, i.e., for the number of equations to exceed the number of variables, so we solve it in a least-squares sense to reach a high-accuracy approximation. The result is the desired quadrature.

For the sake of simplicity, the illustrated embodiment is directed to problems in which the kernel is simply a combination of a smooth function and the product of a smooth function and the Green's function for Laplace's equation. But some embodiments will be directed to broader ranges of problems. In those cases, the system would include further equations to reflect the other types of kernel functions that would be encountered in such problems. These include, for example, normal and tangential derivatives of the Green's function and the second normal derivatives of the Green's function.

Ordinarily, the number of nodes and the resultant number of basis functions will be chosen to be larger in deriving the non-smooth-interval quadratures than in deriving the smooth-interval quadratures. In general, increasing the number of nodes increases the approximation accuracy, and the number of nodes needed to obtain a given accuracy is greater for non-smooth intervals than for smooth intervals.

It is important to note that the “target point” x is a parameter in all of the basis functions: the quadrature arrived at will depend on the x value assumed. This may suggest that the above-described operation of computing a pair of quadratures, one to be used for smooth problem intervals and the other to be used for non-smooth ones, needs to be performed for each x value at which the potential function may need to be evaluated. As will shortly be explained, the illustrated embodiment does not actually store a separate quadrature for each possible target-point location. But it does store a separate one for each possible target-point location that is (1) located on the integration interval and (2) coincides with what we refer to below as a “support node.” We will refer to the quadratures computed for such target nodes located on the integration interval as “self-interaction” quadratures.

To understand what is meant by support node, recall that the values from the problem space are to be mapped into the canonical space in order to evaluate the integral of interest. As will be seen below, that mapping operation's computational stability depends on the problem-space locations at which the function values are given, and a set of problem-interval locations that is good for this purpose does not in general map to the same canonical-interval locations that the quadrature calculations dictate. We will refer to the nodes that the quadratures dictate as “auxiliary nodes,” and we will usually use that phrase in the canonical-space context, although it can also be used to refer to the problem-space location to which the canonical-space auxiliary node maps. The (normally different) nodes whose positions contribute to computational stability in the mapping operation will be referred to as “support nodes.” At some point in its calculations, the solver at least implicitly evaluates problem-space density and/or potential functions at problem-space support nodes.

As was just mentioned, the illustrated embodiment stores, for each support node that lies on the canonical interval, a separate quadrature set calculated with the target node x equal to that support node. FIG. 4 illustrates this. Reference numeral 36 refers to the canonical integration interval, and reference numerals 38a, 38b, etc. identify specific support nodes. For each such integration-interval support node, the generalized-Gaussian-quadrature approach described above is used to compute a smooth-interval quadrature and a non-smooth-interval quadrature. (Actually, illustrated embodiment's support nodes for the smooth-interval case differ because of the above-mentioned accuracy considerations from those for the non-smooth-interval case.)

Now, some of the target points do not lie on the interval being integrated. But many problems involve determining the potential function's values at target points that lie some distance from the integration interval. Some embodiments may therefore store a separate quadrature set (e.g., a separate pair) for each such location in the canonical space to which a target point may be mapped. Doing so is inconvenient, though, and we have recognized that it is unnecessary. Instead, the illustrated embodiment includes only a single quadrature pair for each of several ranges of such x values. As FIG. 4 shows, the space outside the integration interval is divided into a number of concentric regions 40, 42, etc., and a common quadrature set is determined for all target points within the same region.

This is done by performing the above-described generalized-Gaussian-quadrature computation, but with a larger system of equations. Specifically, the system includes a group of equations like equations (16) for each xᵢ in a representative enough group of xᵢ's in the region. It is sufficient in this connection if the xᵢ's are chosen on the region's inner and outer boundaries; if such system can be solved to the desired accuracy, so can a system that includes equations for xᵢ's in the region's interior. In the case of region 40, for example, the xᵢ's would be locations such as the ones marked by the crosses, such as crosses 44 and 46, on that region's inner and outer boundaries. Most embodiments will employ more than the illustrated number of concentric regions; a typical set may be bounded by, say, seven increasingly large rectangles. The size of the largest will depend on considerations such as the desired accuracy. A high-accuracy embodiment may use an outermost rectangle whose dimensions are, say, eighty by twenty times the interval length, and the outermost region would extend from that rectangle to infinity. Its quadrature would be computed from equations for xᵢ's on only that region's inner boundary.

A single set of reasonable-sized quadratures common to the entire innermost region 48 would not afford the accuracy that most embodiments would require. But the illustrated embodiment includes common quadratures for each of a further set of concentric regions defined by boundaries such as boundaries 50 and 52. In the drawing, boundary 50 appears to be three times as large as boundary 52, but the ratios between successive boundaries in a typical embodiment are likely to be more like ten, and there may be, say, fifteen successively smaller regions, each of which is defined by a boundary one-tenth the size of the next-larger one. If an off-boundary target point is located as close to the interval as region 48's interior, the interval is so chosen that its end is near the desired target point and thereby falls within one of the regions defined by successive boundaries 50, 52, etc.

With the precomputed quadratures thus stored, the solver can rapidly solve, with relatively little user intervention, field problems that the user defines by using the keyboard and/or other input devices. In a capacitance measurement, for example, the signals thereby sent by the user to the solver represent, among other things, the shapes of the conductors 26 and 28 between which the conductance is to be determined. In some fashion the signals would also implicitly or explicitly specify the relevant boundary values, e.g., that the potential u is one volt at all of conductor 26's surface nodes and zero at all of conductor 28's. The unknown would be the charge density σ as a function of location y on a conductor's surface; integrating the charge density over the conductor surface will yield the surface's total charge per unit conductor length for that potential difference and thereby the capacitance per unit length between the conductors. Although this example problem involves solving for σ and is particularly simple in the sense that the boundary value is uniform on each surface and that values of potential do not have to be determined throughout the inter-surface region, problems that instead involve finding u and/or include more-complex specifications of boundary values, etc. can be handled as well by solvers that employ the present invention's teachings.

Given the conductors' shapes, the user—or, preferably, the solver—divides the conductor boundary into intervals that are mapped into the canonical interval. The intervals are so chosen that their interiors are geometrically smooth. In FIG. 2, for example, consider conductor 26's surface portion 46. That portion is smooth in its interior but discontinuous at its ends. Unlike the illustrated embodiment, in which the original basis-function factors representing the density function included at most one singularity, other embodiments may include basis functions having singularities at both ends. In such a case, the solver could typically include all of portion 46, which has geometric discontinuities at both ends, in a single problem interval to which the canonical interval is to be mapped. In contrast, the illustrated embodiment would instead divide that portion into at least two intervals so that both discontinuities could be (separately) mapped to (−1, 0) in the canonical interval, where some of the basis functions include singularities.

Other boundary portions would similarly be subdivided. In the case of the curved portion 50, some embodiments may simply divide that portion into two intervals, each of which ends in a discontinuity and would therefore be evaluated by using non-smooth-interval quadratures. Usually, though, it would be subdivided further into intervals that approximate straight line segments more closely. With the exception of the intervals at the ends of that portion, the resultant intervals would be evaluated by using smooth-interval quadratures.

The solver solves the following matrix equation:

u=Aσ. (17)

for u, σ, or various combinations of their elements, where u's elements are the potential-function values at target points of interest, σ's elements are the density-function values at the support nodes, and A's are determined from the problem geometry, the relevant Green's function, and the appropriate stored quadrature. The way in which the illustrated embodiment makes that determination will now be described.

The ith row of u=Aσ is intended to be the discretized version of the following equation:

$$u ( {x}_{i} ) = {\sum }_{p} {\int }_{{B}^{( p )}} G ( {x}_{i} , y ) σ ( y ) ⅆ y , \qquad ( 18 )$$

where Bₚ is the pth problem interval.

To make a discretized version, we want the sum given in equation (18) to be approximated, to within some approximation error, by a sum of the following form:

$$u ( {x}_{i} ) = {\sum }_{p} {\sum }_{m} {A}_{i , pM + m} σ ( y ( {t}_{m}^{( s )} ) ) , \qquad ( 19 )$$

where M is the number of nodes in the problem interval and tₘ^{(s)} is the mth support node. (For the sake of simplicity, we have assumed that all intervals have the same number of support nodes. Since the number of nodes the illustrated embodiment uses for smooth intervals is less than the number it uses for non-smooth intervals, though, this is not necessarily true.)

Now, we are mapping each problem interval to the canonical interval: the locations y of the support nodes are on interval y(t) for (in the particular case of the illustrated embodiment) tε[−1, 1]. We can therefore express the integration as an integral over t as follows:

$${\int }_{- 1}^{1} G ( {x}_{i} , {y}^{( p )} ( t ) ) σ ( {y}^{( p )} ( t ) ) \vert {( {y}^{( p )} )}^{′} \vert ⅆ t , \qquad ( 20 )$$

where y^{(p)}(t) is y's position as a function of t on the pth interval and, for y^{(p)}(t)≡[y₁,y₂],

$$\vert {( {y}^{( p )} )}^{′} \vert ≡ \sqrt{{( \frac{ⅆ {y}_{1}}{ⅆ t} )}^{2} + {( \frac{ⅆ {y}_{2}}{ⅆ t} )}^{2}} .$$

If we were to evaluate this integral numerically in terms of values at the auxiliary nodes, i.e., at the relative interval positions defined in the appropriate pre-stored quadrature, the expression would be:

$${\sum }_{j} G ( {x}_{i} , {y}^{( p )} ( {t}_{j}^{( a )} ) ) σ ( {y}^{( p )} ( {t}_{j}^{( a )} ) ) \vert {( {y}^{( p )} )}^{′} ( {t}_{j}^{( a )} ) \vert {w}_{j}^{( a )} , \qquad ( 21 )$$

where tⱼ^{(α)} is the appropriate stored quadrature's jth auxiliary node and wⱼ is the corresponding weight.

As was explained above, the selection of which quadrature is appropriate depends on the target-point location. To identify the region that contains the target point xᵢ, the solver finds the target point's canonical-space value, i.e., the value that results from mapping the problem-space xᵢ value to the canonical space in accordance with whatever mapping policy the solver implements. For example, the value of x in canonical space could be given by R xᵢ+d, where R is a rotation-and-scaling matrix and d is a translation vector such that, if yₛₜₐᵣₜ and y_{end} are the locations where the problem interval respectively starts and ends, R yₛₜₐᵣₜ+d=[−1,0] and Ry_{end}+d=[1,0].

In the illustrated example, where the first problem interval is a straight line segment, y(t) can readily be defined by y(t)=(yₛₜₐᵣₜ+y_{end})/2+(y_{end}−yₛₜₐᵣₜ)t/2, where yₛₜₐᵣₜ and y_{end} are the problem interval's endpoints, so y′(t)=(y_{end}−yₛₜₐᵣₜ)/2. If the problem interval is instead a segment of curved portion 50 and that portion's parametric equation has been given as input, y′(t) may similarly be evaluated analytically. In problems in which the interval is instead given as a sequence of points yⱼ, other approaches to evaluating y′(t) may be employed. It could be obtained by evaluating an interpolating polynomial's derivative at the auxiliary nodes, or example.

But recall that the illustrated embodiment evaluates at the support nodes tₘ^{(s)} rather than at the auxiliary nodes tⱼ^{(a)}. In cases in which the problem presented to it includes determining values of u, for example, it will have at least implicitly received σ's support-node values. And it is at the support nodes that the illustrated embodiment would determine σ's support-node values in the capacitance-determination example. So the illustrated embodiment in effect expresses the auxiliary-node density-function values σ(y(tⱼ^{(a)}) in terms of the support-node density-function values σ(y(tₘ^{(s)}).

To understand how it does so, recall that the stored-quadrature derivation was based on the assumption that the density function can be closely approximated by a linear combination of basis functions:

$$σ ( y ( {t}_{j}^{( a )} ) ) ≅ {\sum }_{k} {α}_{k} {f}_{k} ( {t}_{j}^{( a )} ) , \qquad ( 22 )$$

where the fₖ's are those basis functions and the coefficients αₖ define respective basis functions' relative contributions.

Although these basis functions will not necessarily be precisely the same as those employed to generate the quadratures, they can be determined, as the quadratures can, once for all problems to which the quadratures will be applied. The coefficients αₖ are not similarly known a priori, but it is known that the density function is defined by the same linear combination of basis functions everywhere in the interval, i.e., not only at the auxiliary nodes but also at the support nodes:

$$σ ( y ( {t}_{m}^{( s )} ) ) ≅ {\sum }_{k} {α}_{k} {f}_{k} ( {t}_{m}^{( s )} ) , \qquad ( 23 )$$

so the coefficients αₖ are given by:

$${α}_{k} = {\sum }_{m} {( {T}^{( s )} )}_{k , m}^{- 1} σ ( y ( {t}_{m}^{( s )} ) ) , \qquad ( 24 )$$

where T^{(s)} is the support-node “interpolation matrix,” whose elements T_{j,i}^{(s)} are fᵢ(tⱼ^{(s)}).

By thus expressing the αₖ's in terms of the density function's support-node values, we arrive at:

$$u ( {x}_{i} ) ≅ {\sum }_{p} {\sum }_{m} {\sum }_{j} {\sum }_{k} G ( {x}_{i} , {y}^{( p )} ( {t}_{j}^{( a )} ) ) \vert {( {y}^{( p )} )}^{′} ( {t}_{j}^{( a )} ) \vert {w}_{j}^{( a )} {{T}_{j , k}^{( a )} ( {T}_{k , m}^{( s )} )}^{- 1} σ ( y ( {t}_{m}^{( s )} ) ) , \qquad ( 25 )$$

where T^{(α)} is the auxiliary-node support matrix, whose elements T_{j,k}^{(α)} are fₖ(tⱼ^{(α)}). This equation tells us that the elements of the matrix A in u=Aσ are given by:

$${A}_{i , pM + m} = {\sum }_{j} {\sum }_{k} G ( {x}_{i} , {y}^{( p )} ( {t}_{j}^{( a )} ) ) \vert {( {y}^{( p )} )}^{′} ( {t}_{j}^{( a )} ) \vert {w}_{j}^{( a )} {{T}_{j , k}^{( a )} ( {T}_{k , m}^{( s )} )}^{- 1} . \qquad ( 26 )$$

In comparison with the computational cost of arriving at the precomputed auxiliary-node quadratures, the burden of calculating a matrix A for each target point x of interest is modest. Also, although the computation involves a matrix inversion, that operation is computationally stable; the support-node interpolation matrix can be assured to be well conditioned if the support nodes are properly chosen.

As those skilled in the art will recognize, what is meant in this context by a “well-conditioned” interpolation matrix will depend on the resolution with which the solver-implementing processor performs floating-point operations. Most users will not consider the result acceptably accurate if any of the interpolation matrix's eigenvalues or any of those eigenvalues' reciprocals exceeds a thousand in magnitude. Such interpolation matrices can readily be obtained. As a practical matter, in fact, we have found that it is always possible to find a combination of interpolation basis and support-node choice that will yield an interpolation matrix for which the eigenvalues and their reciprocals are less than ten in magnitude. In the case of smooth-interval quadratures, we have done this by obtaining the interpolation basis through Gram-Schmidt orthonormalization from the basis used to compute the quadratures and simply using the zeroes of the appropriate-order Legendre polynomial as the support nodes. We have used the following ten-node support quadrature, which was obtained this way:

| Nodes: | Weights: |
|---|---|
| −0.9739065285171717E+00 | 0.6667134430868814E−01 |
| −0.8650633666889845E+00 | 0.1494513491505806E+00 |
| −0.6794095682990244E+00 | 0.2190863625159820E+00 |
| −0.4333953941292472E+00 | 0.2692667193099964E+00 |
| −0.1488743389816312E+00 | 0.2955242247147529E+00 |
| 0.1488743389816312E+00 | 0.2955242247147529E+00 |
| 0.4333953941292472E+00 | 0.2692667193099964E+00 |
| 0.6794095682990244E+00 | 0.2190863625159821E+00 |
| 0.8650633666889845E+00 | 0.1494513491505806E+00 |
| 0.9739065285171717E+00 | 0.6667134430868814E−01 |

(The weights are the ones we use for a Fast Multipole Method presently to be described, and they can also be used for other purposes not relevant to the invention.) For non-smooth-interval quadratures, we have employed the following support quadrature, which we obtained by using the twenty-point generalized Gauss-Markov quadrature formula that integrates (not necessarily with high accuracy) all pairwise products of Pₙ(t) and Pₙ(t) log(t+1), i.e., functions Qₙ(t), Qₙ(t) log (t+1), and Qₙ(t) log²(t+1), where the Pₙ's are the Legendre polynomials up to order ten, and the Qₙ's are polynomials of orders up to twenty:

| Nodes: | Weights: |
|---|---|
| −0.9999909606636370E+00 | 0.1950871842385528E−04 |
| −0.9997799610697563E+00 | 0.2662027505675124E−03 |
| −0.9983880531605079E+00 | 0.1330822815225500E−02 |
| −0.9933216880104936E+00 | 0.4096625779717666E−02 |
| −0.9802966013274876E+00 | 0.9405892516063258E−02 |
| −0.9536897623709384E+00 | 0.1770796722000426E−01 |
| −0.9075352953881807E+00 | 0.2888568649339209E−01 |
| −0.8366601992463286E+00 | 0.4228014805967799E−01 |
| −0.7376388986888173E+00 | 0.5683072190698195E−01 |
| −0.6094249335085996E+00 | 0.7124786177307433E−01 |
| −0.4536398775629868E+00 | 0.8417920033978898E−01 |
| −0.2745499467193714E+00 | 0.9435468785626824E−01 |
| −0.7877665387981976E−01 | 0.1007067933225627E+00 |
| 0.1252043646185169E+00 | 0.1024614792522233E+00 |
| 0.3277144085289089E+00 | 0.9919650368156321E−01 |
| 0.5186039825289089E+00 | 0.9086415011985853E−01 |
| 0.6879956406760722E+00 | 0.7777954416462867E−01 |
| 0.8269727107133165E+00 | 0.6057949804512051E−01 |
| 0.9281645359667424E+00 | 0.4016242307804314E−01 |
| 0.9862134156531814E+00 | 0.1764428210681433E−01 |

Of course, other approaches to obtaining well-conditioned translation matrices can be used as well.

Now, although description so far has been presented as though the entire numerical integration is performed in accordance with the appropriate auxiliary-node quadratures obtained as described above. In some embodiments, though, they will be used only for a minor portion of the integration, where the results of less-exact quadratures would not be accurate enough.

For example, the solution of equation (17) can be accelerated by adapting to it the Fast Multipole Methods (FMMs), with which, as the following papers evidence, those skilled in the art are familiar:

V. Rokhlin (1985), “Rapid solution of integral equations of classical potential theory”, J. Comput. Phys. 60, 187.

L. Greengard and V. Rokhlin (1987), “A fast algorithm for particle simulations”, J. Comput. Phys. 73, 325.

L. Greengard and V. Rokhlin (1988a), “Rapid evaluation of potential fields in three dimensions”, in Vortex Methods, C. Anderson and C. Greengard (eds.), Lecture Notes in Mathematics, vol. 1360, Springer-Verlag, 121.

L. Greengard (1988), The Rapid Evaluation of Potential Fields in Particle Systems, MIT Press, Cambridge, Mass.

J. Carrier, L. Greengard, and V. Rokhlin (1988), “A fast adaptive multipole algorithm for particle simulations”, SIAM J. Sci. Statist. Comput. 9, 669.

V. Rokhlin (1990), “Rapid solution of integral equations of scattering theory in two dimensions”, J. Comput. Phys. 86, 414.

V. Rokhlin (1993), “Diagonal forms of translation operators for the Helmholtz equation in three dimensions”, Appl. and Comput. Harmonic Analysis 1, 93.

L. Greengard and V. Rokhlin (1997), “A new version of the fast multipole method for the Laplace equation in three dimensions”, Acta Numerica 6, 229.

H. Cheng, L. Greengard and V. Rokhlin (1999), “An Adaptive Fast Multipole Algorithm in Three Dimensions”, J. Comput. Phys. 155, 468.

L. Greengard, J. Huang, V. Rokhlin, and S. Wandzura (1998), “Accelerating fast multipole methods for low frequency scattering”, IEEE Comp. Sci. Eng. 5, 32.

We hereby incorporate those papers in their entirety by reference. In essence, FMMs are schemes for the rapid evaluation of all pairwise forces in a system of interacting particles. If N denotes the number of particles in the system, each particle participates in approximately N interactions. N×N (or N²) work therefore seems to be required. The FMM carries out such computations in time proportional to N or N logN, where the constant of proportionality depends on the desired precision and the details of the implementation. The first five of the above-listed papers considered electrostatic interactions and the next two papers considered high-frequency electrodynamic interactions (HF-FMM).

There have been many papers describing the use of FMMs to accelerate integral-equation-solution techniques. The usual procedure is to use a low-order-accurate discretization (such as constant charge densities on flat triangles (3D) or straight segments (2D) or to use high order Gaussian rules for the far field combined with “local corrections” to handle the singularity in the Green's function. These local corrections have not been available in tabular or closed form; in existing implementations, they require the solution of a modest sized linear system on each triangle/segment or the use of adaptive Gaussian quadrature sometimes with the analytic subtraction of the principal singularity. Moreover, they are not equipped to handle geometric singularities.

But the rules in accordance with which quadratures used in the present invention are developed encompass both the Green's-function singularity and geometric singularities, so they obviate the need for developing local corrections on the fly. A new FMM-based fast algorithm for evaluating layer potentials can therefore proceed in three steps:

1) Computing a first approximation: The boundary is divided into intervals in the manner that was described above. Rather than mapping to the auxiliary-node quadratures as described above in connection with equations (21), (25), and (26), though, the support-node quadratures (or some other common quadratures) are used in integrating all of the intervals for all of the support points; i.e., the quadrature used for a given interval does not depend on the target point for which it is evaluated. In this particular embodiment, the quadratures used for these “far-field” calculations can be the support-node quadratures described above, and the target points will coincide with the support nodes. So, once the support nodes have been assigned for all the intervals, the notion of interval can temporarily be set aside, and the resultant problem is simply of the type in which the interaction of N support nodes with each other is being evaluated: it is the classic FMM problem, in which the integral u(x)=∫G(x,y)σ(y)dy is approximated by the sum:

$$u ( {x}_{i} ) ≅ {\sum }_{p} {\sum }_{m} G ( {x}_{i} , {y}^{( p )} ( {t}_{m}^{( s )} ) ) \vert {( {y}^{( p )} )}^{′} ( {t}_{m}^{( s )} ) \vert {w}_{m}^{( s )} σ ( y ( {t}_{m}^{( s )} ) ) .$$

2) We use a standard “point-based” FMM to evaluate the sums for all desired targets. The contributions to u(x) are high-order accurate for all intervals that are separated from the target x by a great enough multiple of the interval's length (2D) or diameter (3D). (What is “great enough” in the multiplier depends on the accuracy that the particular application demands; in many cases a multiplier of unity is adequate.)

3) We note that the FMM, in the course of its calculation, produces an adaptive quad-tree (2D) or oct-tree (3D) subdivision of space around all intervals and any target points. For each interval in the boundary discretization, we define the boxes in the adaptive tree that contain nodes lying on that particular interval as a “cover” of the segment. We then extend this cover using the tree machinery until all points within some user-specified distance of the interval are contained within the cover. As was stated above, a typical value is the interval length or diameter. From the point of view of this particular segment, it remains only to correct the function values u(x) at the points that lie within the cover. More-distant points are in the far field, and the contribution to the field value from the interval under consideration is considered to have been computed accurately enough already.

For each target point in the cover (which could lie on the interval itself), we subtract the contribution computed from the point-based FMM and replace it with the contribution from the tabulated quadratures.

With those matrices thus computed, the equation u=Aσ can readily be solved for the desired quantity. In the case of the capacitance determination, for example, the solver determines σ by, for example taking u(xᵢ)=1 volt for xᵢ's on one of the conductors and u(xᵢ)=0 volt for xᵢ's on the other conductor. It then generates and sends to a destination, such as one of the storage devices, the communications interface, or the display 24, output signals that represent the capacitance (or, in the two-dimensional case, the capacitance per unit length) between the conductors.

Although the invention has been described for the sake of simplicity in terms of a two-dimensional problem, it is apparent that its teachings are applicable to three-dimensional problems, too. In 3D, the illustrated embodiment maps each problem interval from the three-dimensional problem space to a unit equilateral triangle defined by vertices (0,0), (2,0), (1,√3). If the problem interval's boundary has no geometrical singularities on its boundary, the basis functions are simply T_{m,n}(s,t), where the T_{m,n}(s,t)'s are the orthogonal polynomials of two variables on the unit equilateral triangle, obtained via the Gram-Schmidt orthogonalization process applied to standard two-variable polynomials 1,s,t,s²,t², . . . . The set of basis functions used by the illustrated embodiment for the non-smooth triangle includes, in additional to the same orthogonal polynomials T_{m,n}(s,t), functions that are the product of those polynomials and the logarithm of the distance from the geometrical singularity. For example, the basis used to generate quadratures to be used for a geometrical singularity at the edge corresponding to the canonical bottom edge [(0,0), (2,0)] include functions of the form T_{m,n}(s,t) log t, and the basis used in generating quadratures to be used for a geometrical singularity at a corner corresponding to (0,0) would include functions of the form T_{m,n}(s,t) log \sqrt{s²+t²}.

Note that the number of basis functions can differ in accordance with the location of the non-smooth triangle with respect to geometrical singularity. In practical implementations, most of the non-smooth triangles will be adjacent to exactly one edge or to exactly one corner of the user-specified geometry, in which case the basis functions will include the logarithm of the distance from that particular singularity only. Clearly, it is also possible to employ sets of basis functions that contain singularities at all edges and at all corners or at any combination of them, too. But it is possible to choose the integration-surface tiling in such a way as to avoid such triangles and the need to provide the (typically larger) quadratures that they require. Also note that numerical stability is enhanced if the obtained sets of basis functions are orthonormalized.

The rest of the algorithm remains essentially the same. A set of well-conditioned support nodes is constructed for both smooth and non-smooth triangles, and the auxiliary quadrature tables are constructed for each of the target-node regions. But, in the illustrated embodiment, the Green's function for Laplace's equation in 3D, i.e., 1/(4π|x−y|), is used instead of (½π) log|x−y| to generate the tables.

Also, although we refer to the Green's function for Laplace's equation in describing how the quadratures can be computed, note that those particular functions are not the only ones that can be used to represent singularities in the midst of the interval. Conversely, the use of quadratures generated by using such functions is not limited to integral equations in which the integrand is the product of that function and a “density” function.

What is claimed is:

1. An apparatus for determining field-dependent characteristics comprising:
A) a storage medium containing canonical quadratures; and
B) a computation circuit responsive to signals representing the shape of a boundary that includes geometrical singularities of different angles to:
i) divide the boundary into problem intervals;
ii) for each of a number of target nodes, perform a numerical integration over the boundary of an integrand defined thereon by, for at least some combinations of target node and problem interval that contains a geometrical singularity that induces a singularity in the integrand, performing the integration for that target point node over that problem interval in accordance with a canonical quadrature chosen from among the canonical quadratures independently of what, within a given angle range, the value of that geometric singularity's angle is;
iii) determine the field-dependent characteristic at least in part by employing the results of the numerical integration thus performed; and
iv) generate an output signal indicative of the characteristic thus determined.

2. An apparatus as defined in claim 1 wherein:
A) each of the stored quadratures is associated with a respective position of a target node or a target-node region with respect to a canonical integration interval and is based on the integration, over the canonical integration interval, of the product of a kernel function and a density function, to both of whose domains the canonical interval belongs;
B) each of a plurality of the quadratures is associated with a respective set of at least one density-singularity location on the canonical interval;
C) the value of the kernel function depends on the relative target-node position associated with that quadrature,
D) the density function is independent of the target node's position and exhibits a singularity only at each density-singularity position associated with that quadrature; and
E) the quadrature performs the integration for that target point node over a problem interval by mapping the problem interval to the canonical interval and selecting therefor a said canonical interval associated with a density-singularity position at each point on the canonical interval to which a geometric singularity on that problem interval is thereby mapped.

3. An apparatus as define in claim 1 wherein the computation circuitry:
A) applies a Fast Multipole Method (FMM) using far-field quadratures to provide an FMM result;
B) identifies one or more target points for which the contribution to the FMM result from one or more intervals does not achieve a desired accuracy;
C) removes from the FMM result for each such target point the contribution from each such interval based on the determined one or more points,
D) performs the canonical-quadrature-integration operation for such intervals to obtain a replacement contribution, and,
E) adds the second contribution to the FMM result.

4. An apparatus as defined in claim 1 wherein the number of angle ranges is no more than one thousand.

5. An apparatus as defined in claim 4 wherein the number of angle ranges is no more than one hundred.

6. An apparatus as defined in claim 5 wherein there is only a single angle range.
